(19) United States
(12) Patent Application Publication
(10) Pub. No.: US 2015/0230250 A1
(43) Pub. Date: Aug. 13, 2015

(54) METHOD AND APPARATUS FOR OPERATING SMALL CELL IN WIRELESS COMMUNICATION SYSTEM

(71) Applicant: ELECTRONICS AND TELECOMMUNICATIONS RESEARCH INSTITUTE, Daejeon (KR)

(72) Inventors: Hyung-sub KIM, Daejeon (KR); JeeHyeon NA, Daejeon (KR); Young Jick BAHG, Daejeon (KR); Yeon Seung SHIN, Daejeon (KR)

(73) Assignee: ELECTRONICS AND TELECOMMUNICATIONS RESEARCH INSTITUTE, Daejeon (KR)

(21) Appl. No.: 14/601,351

(22) Filed: Jan. 21, 2015

(30) Foreign Application Priority Data
Feb. 7, 2014 (KR) 10-2014-0014434

(51) Int. Cl. H04W 72/04; H04W 76/02

(52) U.S. Cl. CPC H04W 72/0453; H04W 76/023

(57) ABSTRACT

An apparatus for allocating resources of a cell allocates some of the entire frequency band for a D2D link in the entire zone of the cell, allocates the rest of the entire frequency band for a cellular link in at least some zone of the cell, and allocates time resources different from those of D2D links of adjacent cells to the D2D link.

### CROSS-REFERENCE TO RELATED APPLICATION

This application claims priority to and the benefit of Korean Patent Application No. 10-2014-0014434 filed in the Korean Intellectual Property Office on Feb. 7, 2014, the entire contents of which are incorporated herein by reference.

### BACKGROUND OF THE INVENTION

(a) Field of the Invention

The present invention relates to a method and an apparatus for allocating communication resources in device-to-device (D2D) communication, and more particularly, to a method and an apparatus for allocating communication resources in device-to-device (D2D) communication in a fractional frequency reuse (FFR) based cellular network.

(b) Description of the Related Art

Today, with the spread of various portable terminals including smart phones, users' data usage is rapidly increasing. Mobile carriers are seeing a need to control a sudden increase in traffic, and at the same time, users are expressing dissatisfaction regarding poor QoS.

A device-to-device (D2D) technology proposed to solve the above problem is expected to dramatically enhance a user's quality of experience (QoE) while reducing a burden of a network.

A representative example of the D2D technology which supports device-to-device direction communication without infrastructure such as a base station may include WiFi Direct extended based on the IEEE 802.11n, and the like. In the 3GPP and the like, research into D2D communication, etc., based on a cellular system (for example, long term evolution (LTE)) has been actively conducted. The D2D technology based on a cellular network may have advantages of not only improving the user's QoE, but also quickly propagating risk information through the D2D communication when a blackout occurs due to natural disasters to quickly respond to the risk.

Since the D2D technology based on the cellular network uses a frequency band used in the existing cellular network, interference occurs between D2D links which are established in the D2D and interference occurs between a cellular link and the D2D links which are established in terminals and a base station, which has a negative effect on overall system performance.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for allocating communication resources in device-to-device communication having advantage of reducing interference between a cellular link and D2D links and between the D2D links.

An exemplary embodiment of the present invention provides a method for allocating device-to-device (D2D) communication resources in an apparatus for allocating resources of a cell. The method for allocating resources includes: allocating some of an entire frequency band for a D2D link in an entire zone of the cell; and allocating the rest of the entire frequency band for a cellular link in at least some zone of the cell.

The method for allocating resources may further include allocating time resources different from those of D2D links in adjacent cells to the D2D link in the entire zone of the cell.

The cell may be divided into an inner zone and an outer zone and the inner zone may be divided into a central zone and an outside zone, and the at least some zone may include a zone other than the central zone in the entire zone of the cell.

The method for allocating resources may further include allocating some of the entire frequency band for the cellular link to the central zone of the cell.

The allocating of the rest of the entire frequency band for the cellular link in some zone of the cell may include: dividing the rest of the entire frequency band into a plurality of subbands; allocating the rest of the entire frequency band for the cellular link in the outside zone of the cell; and dividing the outer zone of the cell into a plurality of zones to allocate the plurality of subbands to the plurality of zones, respectively.

An advertisement message may be transmitted through the D2D link at the time resource allocated to the D2D link in the cell.

The allocating of the time resources different from those of D2D links in adjacent cells to the D2D link in the cell may include: determining an integer n satisfying n=i mod R; determining an integer x satisfying x=n×w; determining an integer a satisfying a=x mod 10; and determining RF satisfying RF mod T=FLOOR x/10, in which the advertisement message may be transmitted at each period T for w starting from an a-th subframe of a frame of the RF, and the i may represent an index of the cell, the R may represent a frequency reuse coefficient, the FLOOR( ) may return a maximum integer value which is equal to or smaller than a factor in parenthesis, and the mod may represent a modular operation.

The cell may be divided into an inner zone and an outer zone and the allocating of the rest of the entire frequency band for the cellular link in some zone of the cell may further include allocating the rest of the entire frequency band to the cellular link in the cell and outer zones of the adjacent cells using the frequency reuse coefficient.

The method for allocating resources may further include transmitting resource allocation information of the D2D link to a D2D terminal in the cell.

Another embodiment of the present invention provides an apparatus for allocating device-to-device (D2D) communication resources in a cell. The apparatus for allocating resources may include a controller and a transceiver. The controller may allocate some of the entire frequency band for a D2D link in the entire zone of the cell, allocate the rest of the entire frequency band for a cellular link in at least some zone of the cell, and allocate time resources different from those of D2D links of adjacent cells to the D2D link. The transceiver may transmit resource allocation information of the cellular link and the D2D link to a D2D terminal in the cell.

One wireless frame may include a plurality of subframes, and the time resource may include at least one of the plurality of subframes.

The cell may be divided into an inner zone and an outer zone and the outer zone may be divided into a plurality of sector zones, and the controller may allocate the rest of the entire frequency band for the cellular link of the plurality of sector zones using a set frequency reuse coefficient.

The controller may divide the rest of the entire frequency band into a plurality of subbands using the frequency reuse coefficient, and allocate the plurality of subbands for the cellular link of the plurality of sector zones so as to not overlap the subbands allocated to the outer zones of the adjacent cells, respectively.

An advertisement message may be transmitted through the D2D link at the time resource allocated to the D2D links in the entire zone of the cell.

The controller may determine an integer n satisfying n=i mod R, determine an integer x satisfying x=n×w, determine an integer a satisfying a=x mod 10, and determine RF satisfying RF mod T=FLOOR x/10, the advertisement message may be transmitted at each period T for w starting from an a-th subframe of a frame of the RF, and the i may represent an index of the cell, the R may represent a frequency reuse coefficient, the FLOOR( ) may return a maximum integer value which is equal to or smaller than a factor in parenthesis, and the mod may represent a modular operation.

The cell may be divided into an inner zone and an outer zone and the inner zone may be divided into a central zone and an outside zone, and the at least some zone may include a zone other than the central zone in the entire zone of the cell.

The controller may allocate some of the entire frequency band for the cellular link to the central zone.

The controller may allocate the rest of the entire frequency band for the cellular link to the outside zone.

### BRIEF DESCRIPTION OF THE DRAWINGS

FIG. 1 is a diagram illustrating an example of a cellular network according to an exemplary embodiment of the present invention.

FIGS. 2 and 3 are diagrams schematically illustrating a method for allocating resources in a cellular network according to an exemplary embodiment of the present invention.

FIG. 4 is a diagram illustrating an example of interference due to a D2D link according to an exemplary embodiment of the present invention.

FIGS. 5 and 6 are diagrams illustrating a method for allocating D2D communication resources according to an exemplary embodiment of the present invention.

FIG. 7 is a flowchart illustrating a method for allocating a subframe to a D2D link according to an exemplary embodiment of the present invention.

FIG. 8 is a diagram illustrating an apparatus for allocating resources according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Hereinafter, a method and an apparatus for allocating communication resources in device-to-device communication according to an exemplary embodiment of the present invention will be described in detail with reference to the accompanying drawings.

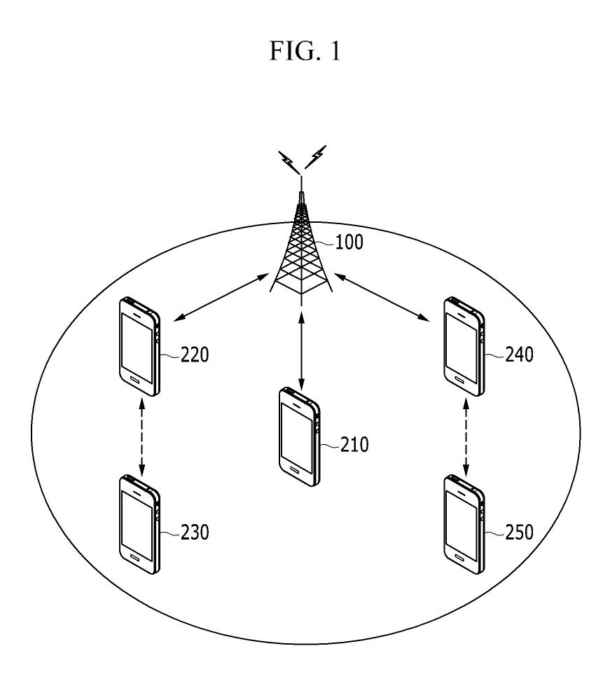

FIG. 1 is a diagram illustrating an example of a cellular network according to an exemplary embodiment of the present invention.

Referring to FIG. 1, the cellular network may include a base station 100 and a plurality of terminals 210 to 250.

The plurality of terminals 210 to 250 may be connected to a cellular network through the base station 100. The plurality of terminals 210 to 250 and the base station 100 are connected to one another through a cellular link (represented by a solid line).

The terminals 220 to 250 may perform D2D communication. Pairs of terminals 220 and 230, and 240 and 250, may be connected to each other through the D2D link (represented by a dotted line). The D2D communication is a scheme to support direct communication with physically proximate terminals without passing through infrastructure such as the base station 100. For example, the terminals 220 and 230 are connected to each other through the D2D link to be able to perform the D2D communication, and the terminals 240 and 250 are connected to each other through the D2D link to be able to perform the D2D communication. The proximate terminals perform the D2D communication to be able to disperse a load of the base station 100 and perform transmission at a relatively short distance to be able to reduce power consumption of the terminals and reduce latency. For convenience of the following description, the terminals 220 to 250 which may perform the D2D communication are referred to as a D2D terminal, and the terminal 210 which may not perform the D2D communication is referred to as a cellular terminal.

The cellular terminal 210 and the D2D terminals 220 to 250 in the cellular network use the same frequency band. That is, since the D2D link shares the cellular link and resources, an interference problem is inevitable. Therefore, when the interference problem is not appropriately controlled, the D2D communication may not only be difficult to perform, but also performance of the cellular terminal 210 may deteriorate. Therefore, to perform the cellular communication based D2D communication, it is very important to effectively control the interference, in which the interference control may be performed by resource allocation.

To reduce inter-cell interference in the cellular network, frequency resources are allocated by a fractional frequency reuse (FFR) scheme.

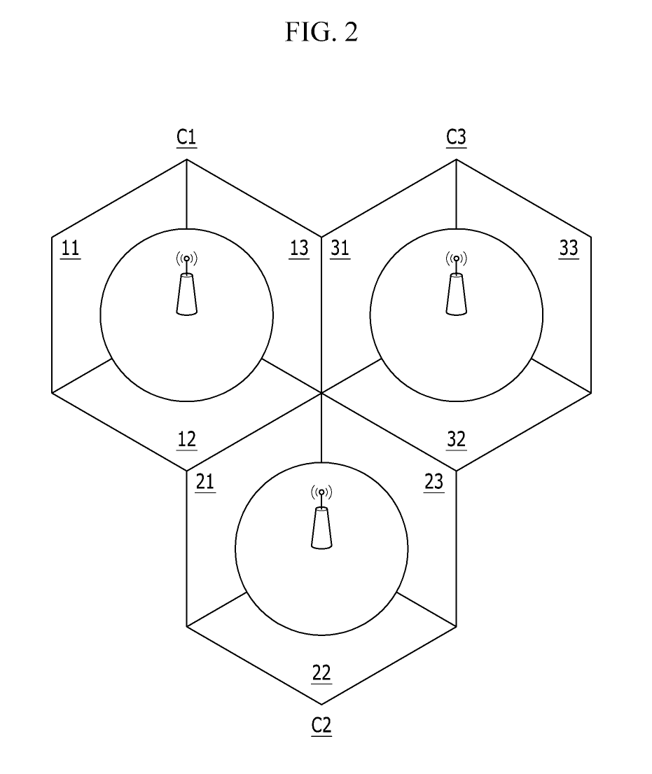

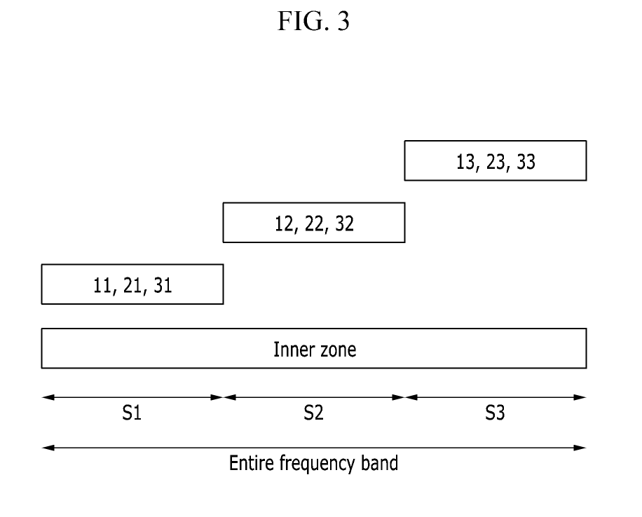

FIGS. 2 and 3 are diagrams schematically illustrating a method for allocating resources in a cellular network according to an exemplary embodiment of the present invention.

As illustrated in FIG. 2, each of cells C1, C2, and C3 in the cellular network may be divided into an inner zone and an outer zone. Further, the outer zones of the cells C1, C2, and C3 may be divided into three sector zones 11, 12, and 13, 21, 22, and 23, and 31, 32, and 33, respectively. The inner zone represents an inside indicated by a circle, and the outer zone represents a zone other than the inner zone indicated by a circle in a cell zone indicated by a hexagon.

Referring to FIG. 3, to reduce the inter-cell interference in the cellular network, resources are allocated by the fractional frequency reuse (FFR) scheme.

The FFR scheme is a scheme which divides a frequency subframe in a radio resource structure which is defined by a two-dimensional zone of time and frequency, and allocates each of the divided frequency resources to each cell to remove the inter-cell interference. For example, when a frequency reuse coefficient is 3, the entire frequency band is divided into three subbands S1, S2, and S3. The inner zones of the cells C1, C2, and C3 are allocated with the entire frequency band, and the outer zones of each of the cells C1, C2, and C3 are allocated with a subband that is mutually exclusive between adjacent cells so as to prevent the inter-cell interference from occurring.

As illustrated in FIG. 3, when the outer zones of the cells C1, C2, and C3 are divided into three sector zones 11, 12, and 13, 21, 22, and 23, and 31, 32, and 33, respectively, each sector zone 11, 12, and 13, 21, 22, and 23, and 31, 32, and 33 of the cells C1, C2, and C3 is allocated with three subbands S1, S2, and S3 so that two sector zones of adjacent cells are allocated with different subbands. For example, the sectors 11, 12, and 13 of the cell C1 are respectively allocated with the subbands S1, S2, and S3, the sectors 21, 22, and 23 of the cell C2 are respectively allocated with the subbands S1, S2, and S3, and the sectors 31, 32, and 33 of the cell C3 are respectively allocated with the subbands S1, S2, and S3. As such, the outer zones of the cells C1, C2, and C3 are each allocated with different subbands from those of the outer zones adjacent to the adjacent cells, and therefore the inter-cell interference may be reduced.

Meanwhile, the D2D communication may be performed at any position within the cell, and the frequency band allocated to the D2D communication is the same as that used in the cellular network.

Therefore, the frequency band used in all the D2D links is the same as that used in the cellular network. As a result, the interference exists between the D2D link and the cellular link.

The interference of a D2D link generated at a central zone of a cell on a D2D link in another cell is insignificant. Therefore, according to the exemplary embodiment of the present invention, only a D2D link positioned at a boundary area between cells is of interest.

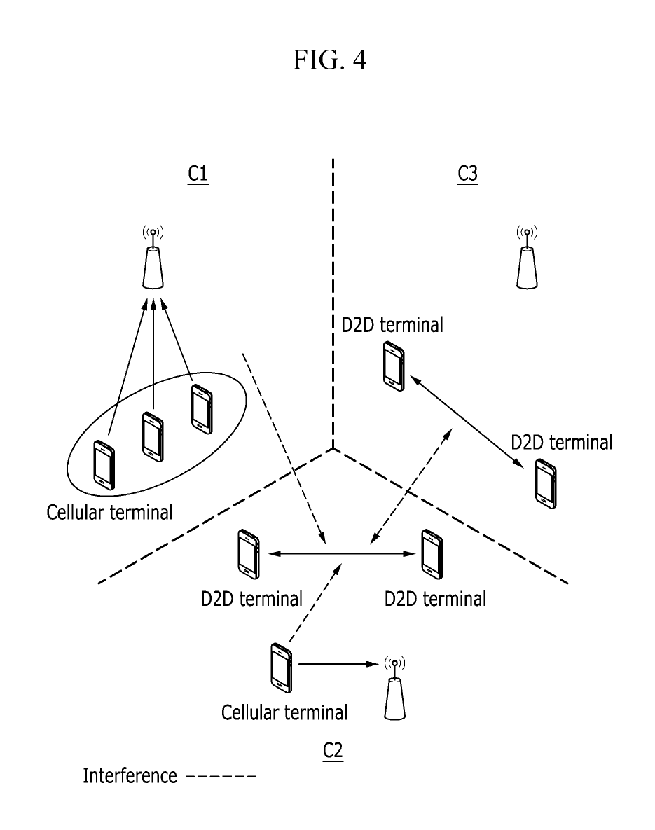

FIG. 4 is a diagram illustrating an example of interference due to a D2D link according to an exemplary embodiment of the present invention.

As illustrated in FIG. 4, in the outer zones of the cells C2 and C3, the D2D communication is performed through the D2D link connected between two D2D terminals, and in the outer zones of the cells C1 and C2, the cellular communication is performed through the cellular link through which the cellular terminals are each connected to base stations of the cells C1 and C2. In this case, the cellular link may have interference on the D2D link and interference between the D2D links in different cells.

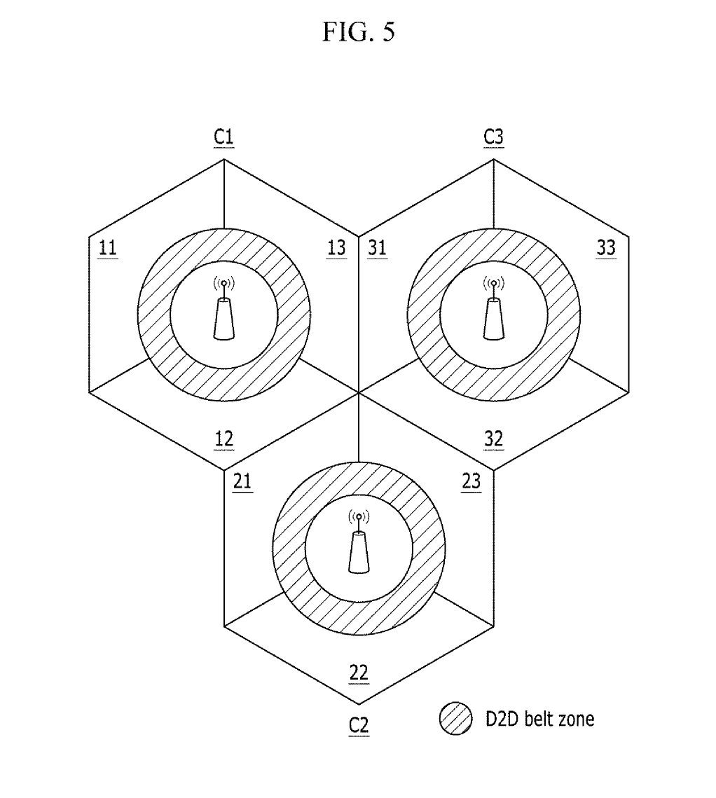

A method for allocating resources to the D2D link to prevent the interference from occurring between the cellular link and the D2D link and between the D2D links will be described with reference to FIGS. 5 to 7.

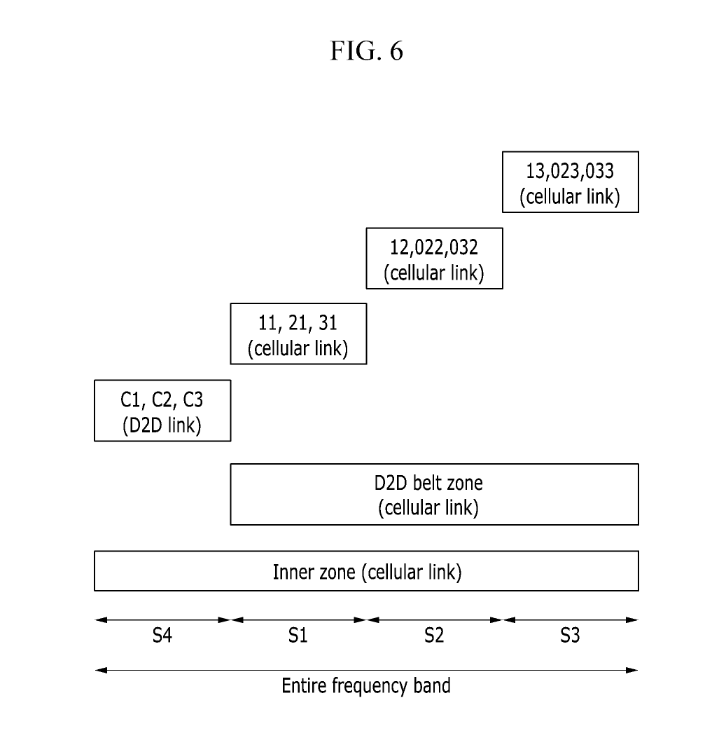

FIGS. 5 and 6 are diagrams illustrating a method for allocating D2D communication resources according to an exemplary embodiment of the present invention.

Referring to FIG. 5, an apparatus for allocating resources introduces a D2D belt zone to solve the interference problem occurring between the D2D link and the cellular link.

As illustrated in FIG. 3, the apparatus for allocating resources allocates the frequency resources to the cellular links in the cells C1, C2, and C3 by the FFR scheme. In this case, however, the cellular link within the outer zones 11, 12, and 13, 21, 22, and 23, and 31, 32, and 33 of the cells C1, C2, and C3 uses only some of the frequency bands. The apparatus for allocating resources allocates different subbands from those allocated to the cellular link within the outer zones 11, 12, and 13, 21, 22, and 23, and 31, 32, and 33 of the cells C1, C2, and C3 to the D2D link to prevent the interference from occurring between the cellular link and the D2D link.

However, the inner zones of the cells C1, C2, and C3, which may use the entire frequency band, use the same frequency band as the outer zones of their own cells or adjacent cells, and therefore the interference occurs. The interference may be said to occur due to the cellular terminals in outside zones of the inner zones of the adjacent cells rather than in the central zones of the inner zones of the adjacent cells. Therefore, the apparatus for allocating resources divides the inner zone of the cell into the central zone and the outside zone, that is, the D2D belt zone, and allocates resources for only the D2D link to the D2D belt zone.

In detail, referring to FIG. 6, when the frequency resource of the frequency reuse coefficient 3 is allocated by the FFR scheme, the entire frequency band is divided into four subbands S1, S2, S3, and S4 to allocate the resources for only the D2D link.

One subband S4 of the subbands S1, S2, S3, and S4 is allocated to the D2D links in each of cells C1, C2, and C3. Three subbands S1, S2, and S3 of the subbands S1, S2, S3, and S4 are allocated for the cellular links in the outer zones of each of the cells C1, C2, and C3 so as to not overlap the outer zones of the adjacent cells as described with reference to FIG. 3. Further, the three subbands S1, S2, and S3 are allocated for the cellular links in the D2D belt zone of each of the cells C1, C2, and C3. Further, the entire frequency band is allocated for the cellular links in the central zones of the inner zones of each of the cells C1, C2, and C3. The subband S4 is allocated for only the D2D links in the D2D belt zones of the inner zones of each of the cells C1, C2, and C3, and the three subbands S1, S2, and S3 are allocated for the cellular links in the D2D belt zones. By doing so, it is possible to reduce the interference between the D2D links in the D2D belt zones and the cellular links in the outer zones of their own cells or adjacent cells. However, the subband S4 allocated for the D2D links in each of the cells C1, C2, and C3 is the same, and therefore the interference between the D2D links in the adjacent cells still exists.

The D2D terminals periodically transmit and receive an advertisement message through the connected D2D links. The D2D terminal may not properly receive the advertisement message due to the interference between the D2D links.

The apparatus for allocating resources according to the exemplary embodiment of the present invention focuses on the advertisement message periodically transmitted through the D2D link to perform the resource allocation for reducing the interference between the D2D links.

The apparatus for allocating resources transmits the advertisement messages transmitted through the D2D links to each cell only in the specific subframe to remove the interference between the D2D links using the same frequency resource and smoothly provides D2D advertisement services. In particular, the apparatus for allocating resources allocates time resources (subframes) for which the interference between the D2D links does not occur to the D2D links in each cell to reduce the interference between the D2D links.

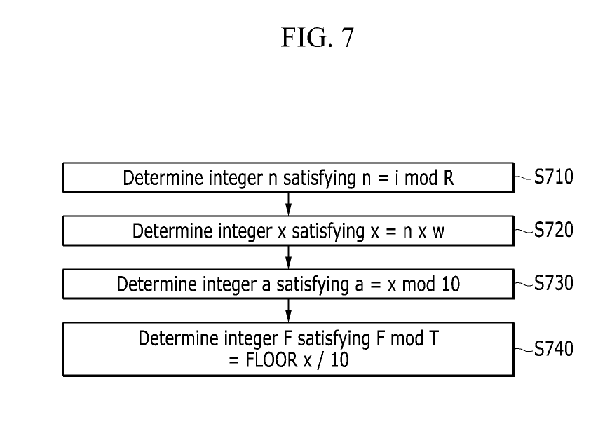

FIG. 7 is a flowchart illustrating a method for allocating a subframe to a D2D link according to an exemplary embodiment of the present invention.

First, the advertisement messages are provided through each D2D link for a specific time, which is the same in all the cells. The advertisement messages through each D2D link are transmitted at each constant period, and a period T is set to be a multiple of a wireless frame. In this case, one wireless frame has a length of 10 ms and may be divided into 10 subframes, in which one subframe has a length of 1 ms.

As such, under the assumption that the advertisement message is transmitted through the D2D link, the apparatus for allocating resources determines the wireless frame and the subframe which are to be used in the D2D link in the cell.

Referring to FIG. 7, the apparatus for allocating resources determines an integer n satisfying n=i mod R to determine the wireless frame and the subframe which are allocated to a D2D link in a cell i. Here, mod represents a modular operation and R represents the frequency reuse coefficient. In the case of FIG. 6, the frequency reuse coefficient may be 3. Here, i represents an index of the cell.

The apparatus for allocating resources determines an integer x satisfying x=n×w (S720).

The apparatus for allocating resources determines an integer a satisfying a=x mod 10 (S730). The advertisement message is transmitted through the D2D link for w starting from an a-th subframe.

The apparatus for allocating resources determines an integer F satisfying F mod T=FLOOR x/10 (S740). The first advertisement message transmission starts at a frame of F satisfying F mod T=FLOOR x/10, and is repeated at each period T. The FLOOR( ) is a function for returning a maximum integer value which is equal to or smaller than a factor in parenthesis.

By doing so, different subframes may each be allocated to the adjacent cells, and therefore the interference between the D2D links in the adjacent cells may be reduced.

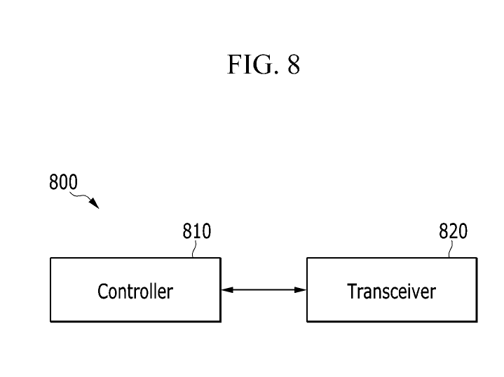

FIG. 8 is a diagram illustrating an apparatus for allocating resources according to an exemplary embodiment of the present invention.

Referring to FIG. 8, an apparatus 800 for allocating resources includes a controller 810 and a transceiver 820. The apparatus 800 for allocating resources may be included in the base station 100 or may be the base station 100 itself.

The controller 810 performs the frequency resource allocation to both of the cellular link and the D2D link. The controller 810 performs the time resource allocation to the D2D link. In detail, the controller 810 allocates the frequency resources to the cellular link and the D2D link as the method described with reference to FIG. 6. The controller 810 allocates the frequency resources to the cellular link and the D2D link, and then allocates different subframes to the D2D links in the adjacent cells to remove the interference between the D2D links in the adjacent cells using the same resource. The controller 810 may allocate the subframe to the D2D link in the corresponding cell by the method described with reference to FIG. 7 to allocate different subframes to the D2D links in the adjacent cells.

The transceiver 820 transmits the resource allocation information of the cellular link and the D2D link to the cellular terminal and the D2D terminal

At least some functions of the method and apparatus for allocating resources for D2D communication according to the exemplary embodiment of the present invention as described above may be implemented by hardware or software combined with the hardware. For example, processors, such as a central processing unit (CPU), other chipsets, and a microprocessor, may perform a function of the controller, and a transceiver may perform a function of the transceiver.

According to the exemplary embodiments of the present invention, it is possible to remove the interference and smoothly provide the services by dividing allocated resources to the cellular link and the D2D link into the frequency subframe and the time subframe and allocating the resources.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for allocating device-to-device (D2D) communication resources in an apparatus for allocating resources of a cell, the method comprising:
allocating some of an entire frequency band for a D2D link in an entire zone of the cell; and
allocating the rest of the entire frequency band for a cellular link in at least some zone of the cell.

2. The method of claim 1, further comprising
allocating time resources different from those of D2D links in adjacent cells to the D2D link in the entire zone of the cell.

3. The method of claim 2, wherein:
the cell is divided into an inner zone and an outer zone and the inner zone is divided into a central zone and an outside zone; and
the at least some zone includes a zone other than the central zone in the entire zone of the cell.

4. The method of claim 3, further comprising
allocating some of the entire frequency band for the cellular link to the central zone of the cell.

5. The method of claim 3, wherein
the allocating of the rest of the entire frequency band for the cellular link in some zone of the cell includes:
dividing the rest of the entire frequency band into a plurality of subbands;
allocating the rest of the entire frequency band for the cellular link in the outside zone of the cell; and
dividing the outer zone of the cell into a plurality of zones to allocate the plurality of subbands to the plurality of zones, respectively.

6. The method of claim 2, wherein
an advertisement message is transmitted through the D2D link at the time resource allocated to the D2D link in the cell.

7. The method of claim 6, wherein
the allocating of the time resources different from those of D2D links in adjacent cells to the D2D link in the cell includes:
determining an integer n satisfying n=i mod R;
determining an integer x satisfying x=n×w;
determining an integer a satisfying a=x mod 10; and
determining RF satisfying RF mod T=FLOOR x/10,
wherein the advertisement message is transmitted at each period T for w starting from an a-th subframe of a frame of the RF, and
the i represents an index of the cell, the R represents a frequency reuse coefficient, the FLOOR( ) returns a maximum integer value which is equal to or smaller than a factor in parenthesis, and the mod represents a modular operation.

8. The method of claim 7, wherein
the T is set to be a multiple of the frame.

9. The method of claim 7, wherein:
the cell is divided into an inner zone and an outer zone; and
the allocating of the rest of the entire frequency band for the cellular link in some zone of the cell further includes allocating the rest of the entire frequency band to the cellular link in the cell and outer zones of the adjacent cells using the frequency reuse coefficient.

10. The method of claim 2, further comprising
transmitting resource allocation information of the D2D link to a D2D terminal in the cell.

11. An apparatus for allocating device-to-device (D2D) communication resources in a cell, comprising:
a controller configured to allocate some of the entire frequency band for a D2D link in the entire zone of the cell, allocate the rest of the entire frequency band for a cellular link in at least some zone of the cell, and allocate time resources different from those of D2D links of adjacent cells to the D2D link; and
a transceiver configured to transmit resource allocation information of the cellular link and the D2D link to a D2D terminal in the cell.

12. The apparatus of claim 11, wherein:
one wireless frame includes a plurality of subframes; and
the time resource includes at least one of the plurality of subframes.

13. The apparatus of claim 11, wherein:
the cell is divided into an inner zone and an outer zone and the outer zone is divided into a plurality of sector zones; and
the controller allocates the rest of the entire frequency band for the cellular link of the plurality of sector zones using a set frequency reuse coefficient.

14. The apparatus of claim 13, wherein
the controller divides the rest of the entire frequency band into a plurality of subbands using the frequency reuse coefficient, and allocates the plurality of subbands for the cellular link of the plurality of sector zones so as to not overlap the subbands allocated to the outer zones of the adjacent cells, respectively.

15. The apparatus of claim 13, wherein
an advertisement message is transmitted through the D2D link at the time resource allocated to the D2D links in the entire zone of the cell.

16. The apparatus of claim 15, wherein:
the controller determines an integer n satisfying n=i mod R, determines an integer x satisfying x=n×w, determines an integer a satisfying a=x mod 10, and determines RF satisfying RF mod T=FLOOR x/10;
the advertisement message is transmitted at each period T for w starting from an a-th subframe of a frame of the RF; and
the i represents an index of the cell, the R represents a frequency reuse coefficient, the FLOOR( ) returns a maximum integer value which is equal to or smaller than a factor in parenthesis, and the mod represents a modular operation.

17. The apparatus of claim 11, wherein:
the cell is divided into an inner zone and an outer zone and the inner zone is divided into a central zone and an outside zone; and
the at least some zone includes a zone other than the central zone in the entire zone of the cell.

18. The apparatus of claim 17, wherein
the controller allocates some of the entire frequency band for the cellular link to the central zone.

19. The apparatus of claim 17, wherein
the controller allocates the rest of the entire frequency band for the cellular link to the outside zone.
